(19) United States
(12) Patent Application Publication
(10) Pub. No.: US 2003/0222057 A1
(43) Pub. Date: Dec. 4, 2003

(54) Laser perforator for music media

(76) Inventor: Eugene P. Gerety, Seymour, CT (US)

Correspondence Address: Eugene P. Gerety, 7 Deer Run Drive, Seymour, CT, 06483, US

(21) Appl. No.: 10/453,331

(22) Filed: Jun. 3, 2003

Related U.S. Application Data
(60) Provisional application No. 60/385,335, filed on Jun. 3, 2002.

(51) Int. Cl. B23K 26/38

(52) U.S. Cl. 219/121.7

(57) ABSTRACT

A technique for perforating paper-like music media for mechanical music devices such as player pianos, orchestrions, nickelodeons, band-organs, fairground organs, etc., is disclosed. Perforation is accomplished by modulating and directing a laser cutting beam over the surface of the paper-like music medium to perforate the medium. The laser perforator also slits the medium to width as it perforates, permitting the use of standard media widths.

### CROSS-REFERENCE TO RELATED APPLICATIONS

This applications claims priority of U.S. Provisional Patent Application No. 60/385335 filed on Jun. 3, 2002 by Eugene P. Gerety.

### TECHNICAL FIELD OF THE INVENTION

The present invention relates to mechanical music devices, more particularly to music media (e.g., piano rolls) for mechanical music devices, and still more particularly to techniques for perforating music media for mechanical music devices.

### BACKGROUND OF THE INVENTION

Mechanical music devices such as player pianos, roll-playing organs, fairground organs, band organs, orchestrions, nickelodeons, and a wide variety of other mechanical musical instruments have been available for over 100 years. Most of these instruments play music rolls or “book music” of one form or another. Music rolls are generally similar to the familiar piano roll used on player pianos. Book music is generally made of a thicker cardboard-like stock and kerfed (or hinged) to fold in fan-fold fashion, much like fan-fold printer paper. When played on a book-playing instrument, the book music is usually placed in a stack (the “book”) and the top “leaf” is fed into the instrument. As the instrument plays, book music is pulled from the stack and feeds out of the instrument where it folds up into another similar fan-fold stack (book).

Some music media, such as rolls for the Regina Sublima piano, are made up of a thicker, paper-like material similar to that used for making file folders.

All of these media will be referred to hereinafter as “paper-like music media”.

A variety of techniques have been employed for perforating paper-like music media, all involving one form or another of die-punch. Commercial perforators have a bank of punches arranged to coincide with desired punch positions on a paper-like music medium. As the medium is passed under the punches, selected ones of the punches are “fired” either mechanically or by solenoids to create perforations in the paper-like music medium. Typically the music medium is stepped forward in a “punch-step increment”, usually on the order of 1/30 of an inch, although some punches use finer punch increments.

Other types of perforators have been built with fewer punches, wherein the punches are moved across the music medium to a desired position and then activated to produce a perforation. The music medium is “stepped” forward, at each step location pausing long enough for the movable punch head(s) to make all required perforations.

Except for manual perforation techniques, which do not lend themselves well to commercial roll production, most music media are perforated in essentially the same way.

There are a number of disadvantages of these prior-art perforation techniques, including, but not limited to the following

Relatively coarse punch-step increment, yielding coarse temporal resolution

The relatively coarse punch-step increment of typical perforators results in a relatively coarse temporal interpretation of the music being perforated, becoming more noticeable on fast passages, at slow media speeds, or for closely-spaced musical events.

Inability to use “standard” media widths

These mechanical punches all require media slit-to-width. Sometimes a perforator will integrate a slitter as a pre or post-process operation to permit the use of standard media widths, but considerable setup is required.

Lack of Flexibility

Once set up for a specific media format, considerable effort is required to “re-tool” for different formats. It is virtually impossible to rapidly switch from one media format to another, and format changes often require a “punch-bank” change. Such punch banks are extremely expensive.

Another problem with prior-art perforation techniques is related to realities of today's mechanical music marketplace, which differs greatly from the marketplace of 100 years ago.

In the heyday of mechanical music devices, there was considerable demand for music media of all types. Mechanical musical instruments were being widely produced by a number of manufacturers. There was considerable incentive to produce and stock large numbers of rolls (and other media forms) in a wide variety of titles for a wide variety of machines.

It is in this environment that many of the commercial music media perforation devices were designed. The commercial devices were designed to punch as rapidly as possible, often through as many as 16 thicknesses of medium (to produce 16 copies at a time). The music roll (book, etc.) market could easily support and justify substantial roll inventories.

Today, however, mechanical music devices are more of a nostalgic novelty. While many thousands of instruments still exist in working order, few manufacturers still produce them and there is no longer a huge mass-market for music media. While most commercial perforating devices were designed for high-speed, high-volume production, today's market for music media does match their capabilities well.

Some mechanical music devices (instruments) used relatively uncommon perforation formats. For example, the Angelus-Artrio reproducing piano (only a small number of which survive today), does not use the “standard” 11.25″ wide, 9 hole-to-the-inch format of most player pianos. This non-standard format has effectively “orphaned” these instruments, and has turned existing rolls into highly prized and sought-after items. New rolls for these instruments are often difficult or impossible to obtain.

While many instruments have been and continue to be restored to working order, it is difficult or impossible to restore old music media, which tend to become brittle and “crumble” when they age. Many rare titles that are no longer produced have been lost to this aging process. Unfortunately, market realities and the economics of prior-art perforating techniques tend to conspire against replacement of these old music media.

### BRIEF DESCRIPTION (SUMMARY) OF THE INVENTION

It therefore is a general object of the present invention to provide an improved technique for perforating paper-like music media such as paper, cardboard, mylar sheet, and other substantially planar media capable of being perforated for use as music media.

It is a further object of the present invention to provide a perforator for music media without mechanical punches and/or dies.

It is a further object of the present invention to provide a perforator for music media capable of accepting standard media widths (e.g., standard bulk paper roll widths) while producing “product” (e.g., perforated music rolls) of width other than those standard media widths.

It is a further object of the present invention to provide a perforator for music media capable of perforating two or more different “products” (e.g., music rolls) simultaneously.

It is a further object of the present invention to provide a perforator for music media that can be switched rapidly between perforation formats with little or no mechanical setup.

These goals and others are achieve by employing a laser to perforate music media.

According to the invention, a laser perforator for music media comprises a laser providing a cutting beam, means for focusing/converging the cutting beam, means for passing a paper-like music medium under the cutting beam, and means for moving the cutting beam over the planar, paper-like medium to form perforations therein.

The laser perforator for music media uses a laser as a source of a cutting beam for perforating paper. The laser is collimated and/or focused down to a small spot, modulated and directed across the surface of a paper-like music medium for the purpose of forming perforations therein.

According to an aspect of the invention, the laser perforator can employ a commercial X-Y laser engraver as a cutting device for perforating the music media. A drive mechanism is provided for feeding the music medium into the engraver and into a cutting area of the laser engraver for perforation. The music medium can be fed either continuously, in stepped fashion, or in “panels”. The music medium can be perforated in either raster fashion, whereby large areas are traced by the laser engraver with the cutting beam being turned “on” over areas to be perforated (removed), or in vector fashion, whereby the cutting beam traces perforation outlines, thereby separating perforated “chad” from the music medium.

Further, according to the invention, the music medium can be slit to width by the laser cutting beam as it is perforated.

According to another aspect of the invention, a printhead can be provided for printing tempo markings, words, dynamic markings and/or other graphical items on the music medium. By coordinating the printing with the motion of the music medium through the laser perforator, the printing can be synchronized with perforations on the music medium (such as words on “word rolls” which appear as their corresponding notes are being played on a mechanical musical instrument such as a player piano).

A variety of different techniques for directing a laser cutting beam can be employed by the laser perforator, such as a rotating polygonal mirror or one or more galvanometer driven mirrors. Commercial marking heads, which usually embody on of these techniques can also be employed to deflect and direct the cutting beam.

Since the useful cutting area provided by beam deflecting mechanisms is often considerably smaller than the width of a typical music medium “product” (e.g., piano roll), the inventive laser perforator can employ these mechanisms by providing a gantry mount whereby the entire cutting mechanism is attached to a movable mount whereby the cutting area can be moved across the music medium to permit perforation over the entire width thereof.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawings. The drawings are intended to be illustrative, not limiting. Although the invention will be described in the context of these preferred embodiments, it should be understood that it is not intended to limit the spirit and scope of the invention to these particular embodiments.

Often, similar elements throughout the drawings may be referred to by similar references numerals. For example, the element 199 in a figure (or embodiment) may be similar or analogous in many respects to an element 199A in another figure (or embodiment). Such a relationship, if any, between similar elements in different figures or embodiments will become apparent throughout the specification, including, if applicable, in the claims and abstract. In some cases, similar or related elements may be referred to with similar numbers in a single drawing. For example, a plurality of elements 199 may be referred to as 199A, 199B, 199B, etc.

The structure, operation, and advantages of the present preferred embodiment of the invention will become further apparent upon consideration of the following description taken in conjunction with the accompanying drawings, wherein:

FIGS. 1A and 1B are block diagrams of laser perforators for music media, according to the present invention.

FIG. 2 is a diagram of a media drive mechanism for the laser perforator of FIG. 1A, according to the invention.

FIGS. 3A, 3B and 3C are diagrams of take-up assemblies for laser perforators, according to the invention.

FIG. 4A is a diagram showing raster-style perforation of a paper-like music medium, according to the invention.

FIG. 4B is a diagram showing vector-style perforation of a paper-like music medium, according to the invention.

FIG. 5 is a block diagram of a system for perforating/slitting a paper-like music medium, according to the invention.

FIGS. 6A, 6B and 6c are diagrams of different types of laser perforating apparatus for direct a laser cutting beam to perforate and/or slit a paper-like music medium, according to the invention.

FIGS. 7A and 7B are a side view and a top view, respectively, of a laser perforator head for perforating a paper-like music medium, according to the invention.

FIG. 8 is a block diagram of a system for perforating/slitting a paper-like music medium, according to the invention.

### DETAILED DESCRIPTION OF THE INVENTION

The invention relates to a technique for perforating planar paper-like music media such as piano rolls, organ rolls, and other similar perforated music media. Such music media are not necessarily stored in roll form and can be quite thick (compared to conventional notions of “paper”). For example, many “keyed” fairground organs employ a thick card stock medium arranged in a fan-fold configuration. The medium itself need not be “paper” either. Other suitable materials may be substituted. For example, mylar sheet material or any other material capable of being perforated may be substituted. It is expressly intended that the laser perforator of the present invention be applied to any substantially planar medium capable of being perforated by a laser perforator to act as a music medium for mechanical, electrical and/or pneumatic musical instruments operated by punched media.

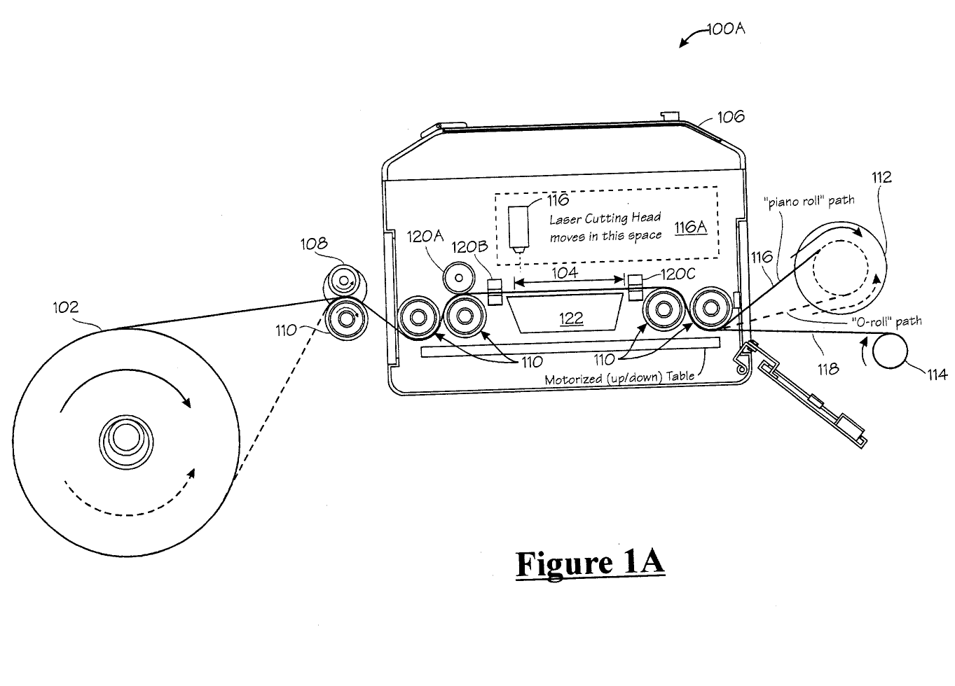

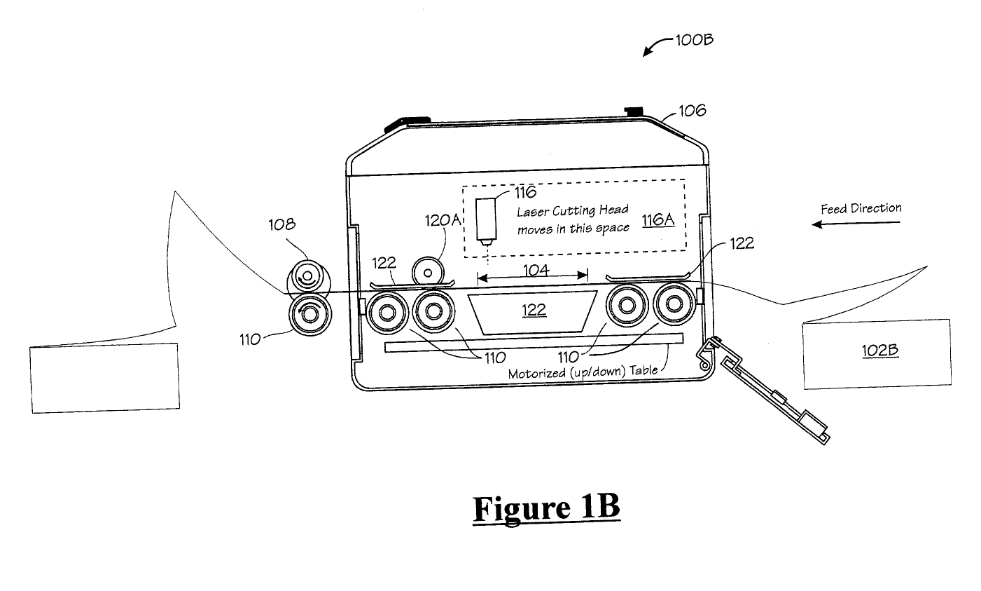

FIG. 1A is a block diagram of a laser perforator for music media 100A wherein a paper medium 102 is fed through a cutting area 104 in a laser engraver 106 (such as a LaserPro Mercury 30 Watt laser engraver, manufactured by Great Computer Corp. of Taiwan, or similar). The paper medium 102 is driven by a paper drive mechanism 108 over a series of guide rollers 110 and onto a product takeup spool 112 and a scrap takeup spool 114. The paper drive mechanism 108 can be a stepping drive that “steps” the paper medium 102 in small, predictable increments, or it can be a conventional motor drive mechanism. As the paper moves through the cutting area 104, a laser cutting head 116 moving in an area 116A over the cutting area 104 makes perforations in the paper medium 102, and slits the paper medium 102 to a predetermined width, thereby dividing the paper medium into one or more music roll “product” portions 116 and one or more scrap portions 118. A position encoder 120a measures the amount of paper medium 102 that has traveled through the cutting area 104. Paper edge sensors 120b and 120c detect the edge position of the paper medium 102 as it enters and exits the cutting area 104. In combination, the position encoder 120a and edge sensors 120b and 120c enable accurate determination of the exact amount of paper medium 102 that has been fed and its orientation (both lateral position and “azimuth” angle) in the cutting area 104, permitting the pattern of perforations to be aligned and/or adjusted according to the known position and orientation of the paper medium 102.

The music roll product portion 116 is fed onto the product takeup spool 112, while the scrap portion 118 is fed onto the scrap takeup spool 114. The product takeup spool 112 and the scrap takeup spool 114 are each driven by a tensioning drive arrangement such as a gearmotor with a slip clutch or a torque motor. As such, the product takeup spool 112 and the scrap takeup spool 114 serve not only to collect the music roll product 116 and scrap 118 portions of the paper medium 102, but to maintain tension on the paper medium 102 in the cutting area 104. Preferably, the tensioning forces applied by the product takeup spool 112 and the scrap takeup spool 114 are balanced such that substantially uniform tension is maintained across the entire width of the paper medium 102 in the cutting area 104. A vacuum ventilation and chip removal duct 122 removes smoke and debris from the cutting area 104.

Two primary modes of perforating are possible: vector and raster. In the raster mode of operation, the paper medium is moved either continuously or in stepped fashion by the paper drive mechanism 108 while the laser head 116 traces across the paper medium 102 perpendicular to the direction of motion of the paper medium 102. The motion of the laser cutting head 116 traces a raster-line pattern over the surface of the paper. The laser's cutting beam is then modulated to produce the desired pattern of perforations in the paper medium 102, by turning the cutting beam “on” (i.e., increasing the cutting beam's power level) as the beam passes over those areas of the paper medium 102 that are to be removed (perforated). Those of ordinary skill in the art will immediately understand that if the paper is moved in stepped fashion by a stepping paper drive 108, the position encoder 120 is useful, but not essential since a sufficiently accurate stepping drive can accurately control the amount of motion of the paper medium 102 without feedback.

In the vector mode of operation, the paper medium 102 can be either moved continuously or “indexed” in “panels”. The laser head 116 traces outlines (in 2-D “X-Y” fashion) of the desired perforations on the paper medium 102, with the laser's cutting beam turned on while tracing perforation outlines and turned off while moving between outlines. This effectively “cuts” or “punches” the outlined area from the paper medium 102, causing the cutout pieces (“chips”) to release from the paper medium 102. The vacuum ventilation and chip removal duct 122 carries the “chips” away.

If the paper medium 102 is moved continuously (or stepped continuously), then the motion of the laser head 116 is adjusted such that the perforation outlines traced by the laser head 116 track the motion of the paper medium 102. If a stepping paper drive mechanism 108 is employed, then the step rate can be controlled and used to synchronize the motion of the laser head 116 with the motion of the paper. If a conventional motor drive (e.g., a gearmotor) is used for the paper drive mechanism 108, then the position encoder 120 provides the paper motion information necessary to synchronize the motion of the laser cutting head 116 to the motion of the paper medium 102.

If the paper is not moved continuously (or stepped continuously) in the vector mode of operation, then it can “indexed” through the cutting area 104 in a series of “panels”. An amount of paper medium 102 (a “panel”) is moved into the cutting area 104 and the paper drive mechanism 108 is stopped, halting the motion of the paper medium 102. The laser head 116 traces outlines of the desired perforations, which releases “chips” from the paper medium 102 as described above. After all of the desired perforations are cut in on “panel” of the paper medium, a new “panel” is indexed into the cutting area 104 and cutting begins again in the new panel. If a conventional motor drive (e.g., gearmotor) is used in indexing the paper medium 102, then the position encoder 120 can be used to determine the exact amount of paper medium 102 indexed into the cutting area 104. This measurement is then used to synchronize the outlines traced by the laser head 114 to the amount of paper medium 102 passed through the cutting area.

Those of ordinary skill in the art will immediately recognize that other hybrid forms of motion and cutting are possible. For example, an “indexed raster” cutting mode is possible wherein the paper medium 102 is indexed in “panels”, and the laser cutting head 116 traces a raster pattern over each panel, with the laser head 116 stepping parallel to the direction of paper travel between perpendicular passes across the paper medium 102 to form the raster pattern.

Combination modes are also possible, with raster cutting used to perform some operations and vector cutting used to perform others. For example, raster cutting might be used to either cut or mark (“scorch”) text annotation into the paper medium 102, while vector cutting might be used for note perforations (i.e., piano roll note perforations).

FIG. 1B is a block diagram of another embodiment of a laser perforator for music media 100B, adapted for perforating thick, fanfold card media 102B. The perforator 100B is similar to the perforator 100A of FIG. 1A in most regards, except that the medium 102B is fed through the cutting area 104 in the opposite direction and that hold-down shoes 122 are used to keep the medium 102B flat in the cutting area.

Those of ordinary skill in the art will understand that the basic techniques shown in FIGS. 1A and 1B can be used as-is can be adapted with different media drive mechanisms to perforate many different kinds of planar paper-like media, including various types of cardboard and plastic media (e.g., mylar).

The paper edge-sensors 120a and 120b can be optical, ultrasonic or other suitable means of detecting the lateral position of the paper edge. Those of ordinary skill in the art will immediately understand that there are numerous devices commercially available for detecting paper edge position. Exemplary of such edge detectors are a line of ultrasonic array edge detectors available from Accuweb, Inc. of Madison, Wis. Those of ordinary skill in the art will also immediately understand that the edge detectors can be used “passively” in a monitoring capacity to report the actual position of the paper edge, “actively” in a control mechanism to actively control the position of the paper edge, or both.

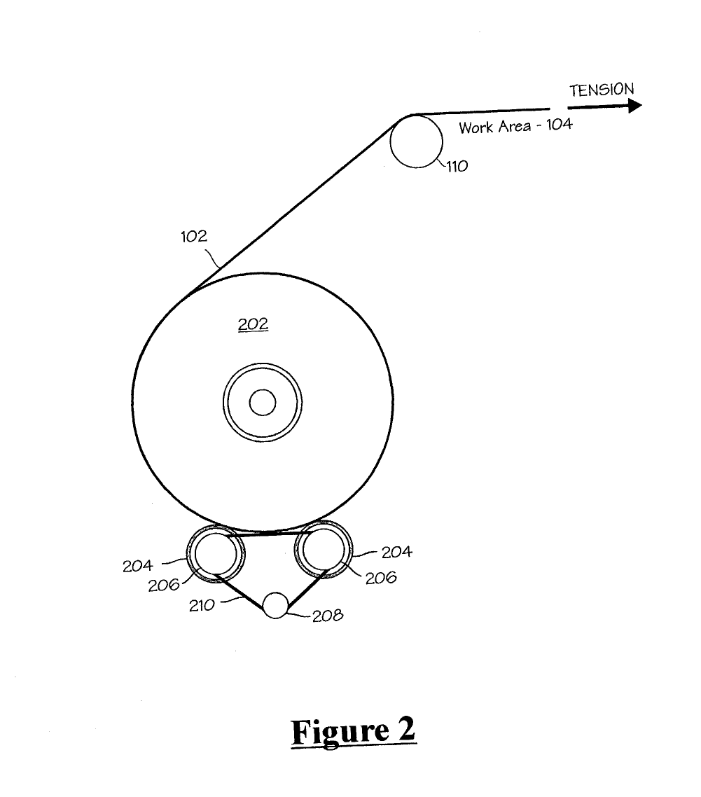

FIG. 2 is a diagram of a paper drive mechanism 200 illustrating a technique for feeding a paper medium 102 off of a heavy roll 202 without unduly stressing the paper medium 102. A pair of parallel horizontal rollers 204, preferably rubber-covered rollers, are spaced apart from one another, forming a “cradle” in which the heavy roll 204 sits. The heavy roll 204 rests on the two rollers and is supported by them. The rollers 204 are each provided with a drive sprocket 206. A motor driven sprocket 208 is disposed near the drive sprockets 206 and a toothed belt 210 passes around the motor driven sprocket 208 and the two drive sprockets such that when the motor-driven sprocket 208 is turned, the toothed belt causes both drive sprockets 206 to turn in the same direction, which causes the rollers 204 to turn. By virtue of friction between the heavy roll 204 and the two rollers 206, the heavy roll 204 is caused to turn by the motion of the two rollers. The paper medium 102 is tensioned by take-up spools (see 112, 114) such that as the heavy roll 202 turns, the paper medium 102 is fed off of the heavy roll through the cutting area 104 and taken up by the takeup spools.

Those of ordinary skill in the art will immediately recognize that similar alternative drive arrangements are possible. For example, gears could be substituted for the sprockets (206,208) and toothed belt 210. By way of further example, it is possible to drive only one of the two rollers 204 (the one nearest an exit point of the paper medium 102 from the heavy roll 202) allowing the other roller to “freewheel”.

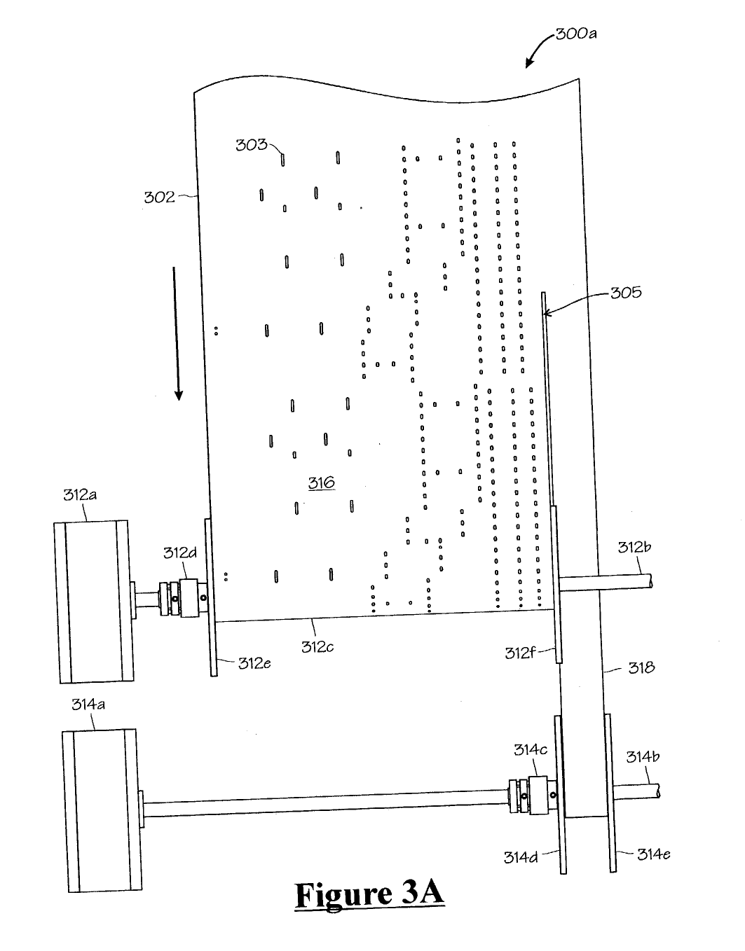

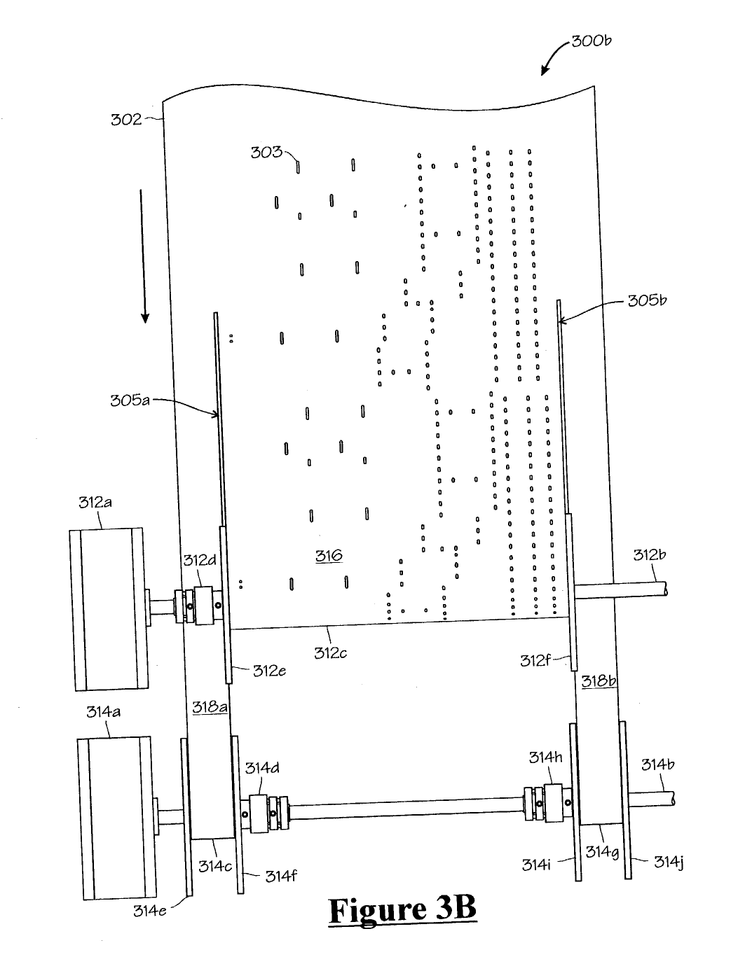

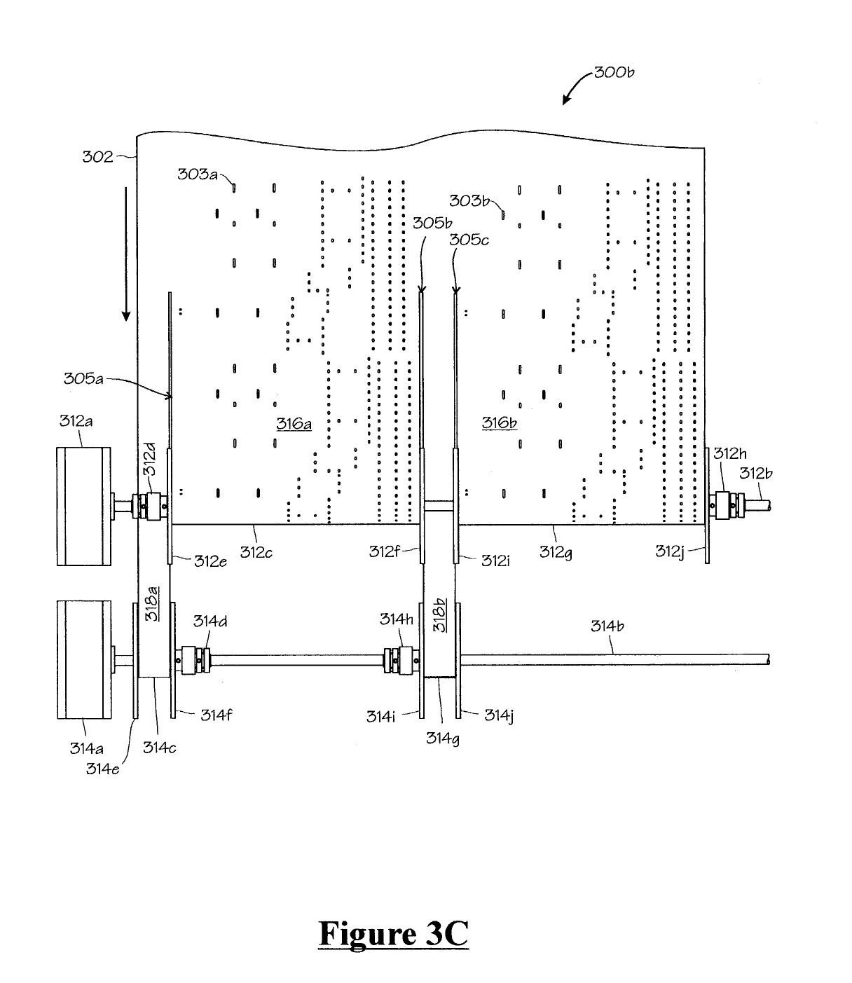

FIG. 3A is a diagram of a take-up assembly 300a for a laser perforator, wherein a paper-like music medium 302 has been perforated by a laser head, forming holes 303 therein. The paper has also been separated into a product portion 316 and a scrap portion 318 by a slit 305 cut into the paper-like medium 302.

A product take-up assembly comprises a product takeup motor 312a, a product takeup shaft 312b driven by the product takeup motor 312a, a product takeup spool 312c, and a continuous-duty slip clutch 312d. The product take-up spool 312c has flanges 312d and 312e, and pivots freely on the product takeup shaft 312b. The slip-clutch 312d is attached to the product takeup shaft 312b and drives the product takeup spool 312c such that torque applied to the product takeup spool 312c by the product takeup shaft 312b is limited to a maximum value set by the slip clutch 312d.

A similar scrap take-up assembly comprises a scrap takeup motor 314a, a scrap takeup shaft 314b driven by the scrap takeup motor 314a, a scrap takeup spool 314c, and a continuous-duty slip clutch 314d. The scrap take-up spool 314c has flanges 314d and 314e, and pivots freely on the scrap takeup shaft 314b. The slip-clutch 314d is attached to the scrap takeup shaft 314b and drives the scrap takeup spool 314c such that torque applied to the scrap takeup spool 314c by the scrap takeup shaft 314b is limited to a maximum value set by the slip clutch 314d.

As the paper-like medium 302 is fed, perforated and slit (e.g., by a mechanism such as that described hereinabove with respect to FIG. 1A), the product portion 316 thereof is collected on the product takeup spool 312c and the scrap portion 316 thereof (assuming that there is a scrap portion) is collected by the scrap takeup spool 314c. The torques applied to the product takeup spool 312c and the scrap takeup spool 314c tension the product portion 316 and scrap portion 318, respectively.

Preferably, the slip clutches 312d and 314d are adjusted such that the tension on the product portion 316 and scrap portion 318 are substantially equal, thereby substantially uniformly tensioning the paper-like medium 302 to minimize the likelihood of “puckering” of the paper-like medium 302.

While FIG. 3A shows a takeup assembly adapated to a perforated medium slit into a single product portion 316 and a single scrap portion 318, the technique is readily adapted to multiple scrap and/or product portions.

FIG. 3B shows a takeup assembly 300b adapted to a perforator setup that divides the paper-like medium into a single product portion 316 and two scrap portions 318a and 318b by slits 305a and 305b formed in the paper-like medium 302 by the perforator. Similar to the takeup assembly 300a of FIG. 3A, the takeup assembly 300b of FIG. 3B has a product takeup assembly and a scrap takeup assembly. In this case, however, the scrap takeup assembly collects the two scrap portions 318a and 318b onto separate scrap spools.

As before, the product take-up assembly comprises a product takeup motor 312a, a product takeup shaft 312b driven by the product takeup motor 312a, a product takeup spool 312c, and a continuous-duty slip clutch 312d. The product take-up spool 312c has flanges 312d and 312e, and pivots freely on the product takeup shaft 312b. The slip-clutch 312d is attached to the product takeup shaft 312b and drives the product takeup spool 312c such that torque applied to the product takeup spool 312c by the product takeup shaft 312b is limited to a maximum value set by the slip clutch 312d.

Similar to the scrap take-up assembly of FIG. 3A, the scrap takeup assembly comprises a scrap takeup motor 314a and a scrap takeup shaft 314b driven by the scrap takeup motor 314a. In this case, however, the scrap takeup assembly further comprises first and second scrap takeup spools 314c and 314g, and first and second continuous-duty slip clutches 314d and 314h. The first scrap take-up spool 314c has flanges 314d and 314e, and pivots freely on the scrap takeup shaft 314b. The second scrap take-up spool 314g has flanges 314i and 314j, and pivots freely on the scrap takeup shaft 314b. The first slip-clutch 314d is attached to the scrap takeup shaft 314b and drives the first scrap takeup spool 314c such that torque applied to the first scrap takeup spool 314c by the scrap takeup shaft 314b is limited to a first maximum value set by the first slip clutch 314d. Similarly, the second slip-clutch 314d is attached to the scrap takeup shaft 314b and drives the second scrap takeup spool 314c such that torque applied to the second scrap takeup spool 314c by the scrap takeup shaft 314b is limited to a maximum value set by the second slip clutch 314d.

As the paper-like medium 302 is fed, perforated and slit (e.g., by a mechanism such as that described hereinabove with respect to FIG. 1A), the product portion 316 thereof is collected on the product takeup spool 312c and the scrap portions 316a and 316b thereof are collected by the first and second scrap takeup spools 314c and 314g, respectively. The torques applied to the product takeup spool 312c and to the first and second scrap takeup spools 314d and 314g tension the product portion 316 and scrap portions 318a and 318b, respectively.

As before, the slip clutches 312d, 314d and 314h are preferably adjusted such that the tension on the product portion 316 and scrap portions 318a and 318b are substantially equal, thereby substantially uniformly tensioning the paper-like medium 302 to minimize the likelihood of “puckering” of the paper-like medium 302.

As described hereinabove with respect to FIG. 1A, the laser perforator of the present invention is capable of producing “one or more” product portions (ref. 116, FIG. 1A) from a paper (or paper-like) medium. For example, a 24″ wide bulk dry-waxed 40# paper medium can be slit to produce two 11.25″ piano rolls (totaling 22.5″ in width) and one or two scrap portions (making up the remainder of the 24″ width of the bulk medium.

FIG. 3C shows a takeup assembly 300b adapted to a perforator setup that divides the paper-like medium into two product portions 316a and 316b and two scrap portions 318a and 318b by means of slits 305a, 305b and 305c formed in the paper-like medium 302 by the perforator. Similar to the takeup assemblies 300a and 300b of FIGS. 3A and 3B, respectively, the takeup assembly 300b of FIG. 3B has a product takeup assembly and a scrap takeup assembly. In this case, however, the product takeup assembly collects the two product portions 316a and 316b onto separate takeup spools.

The product take-up assembly comprises a product takeup motor 312a, a product takeup shaft 312b driven by the product takeup motor 312a, a product takeup spool 312c, and a continuous-duty slip clutch 312d. The product take-up spool 312c has flanges 312d and 312e, and pivots freely on the product takeup shaft 312b. The slip-clutch 312d is attached to the product takeup shaft 312b and drives the product takeup spool 312c such that torque applied to the product takeup spool 312c by the product takeup shaft 312b is limited to a maximum value set by the slip clutch 312d.

Similar to the scrap take-up assembly of FIG. 3B, the product takeup assembly comprises a product takeup motor 312a and a product takeup shaft 312b driven by the product takeup motor 312a. In this case, however, the product takeup assembly further comprises first and second product takeup spools 312c and 312g, and first and second continuous-duty slip clutches 312d and 312h. The first product take-up spool 312c has flanges 312d and 312e, and pivots freely on the product takeup shaft 312b. The second product take-up spool 312g has flanges 312i and 312j, and pivots freely on the product takeup shaft 312b. The first slip-clutch 312d is attached to the product takeup shaft 312b and drives the first product takeup spool 312c such that torque applied to the first product takeup spool 312c by the product takeup shaft 312b is limited to a first maximum value set by the first slip clutch 312d. Similarly, the second slip-clutch 314d is attached to the product takeup shaft 312b and drives the second product takeup spool 312c such that torque applied to the second product takeup spool 312c by the product takeup shaft 312b is limited to a maximum value set by the second slip clutch 312d.

Similar to the scrap take-up assembly of FIG. 3B, the scrap takeup assembly comprises a scrap takeup motor 314a and a scrap takeup shaft 314b driven by the scrap takeup motor 314a. The scrap takeup assembly further comprises first and second scrap takeup spools 314c and 314g, and first and second continuous-duty slip clutches 314d and 314h. The first scrap take-up spool 314c has flanges 314d and 314e, and pivots freely on the scrap takeup shaft 314b. The second scrap take-up spool 314g has flanges 314i and 314j, and pivots freely on the scrap takeup shaft 314b. The first slip-clutch 314d is attached to the scrap takeup shaft 314b and drives the first scrap takeup spool 314c such that torque applied to the first scrap takeup spool 314c by the scrap takeup shaft 314b is limited to a first maximum value set by the second slip clutch 314d. Similarly, the second slip-clutch 314d is attached to the scrap takeup shaft 314b and drives the second scrap takeup spool 314c such that torque applied to the second scrap takeup spool 314c by the scrap takeup shaft 314b is limited to a maximum value set by the second slip clutch 314d.

As the paper-like medium 302 is fed, perforated and slit (e.g., by a mechanism such as that described hereinabove with respect to FIG. 1A), the product portions 316a and 316b thereof are collected on the first and second product takeup spools 312c and 312g, respectively, and the scrap portions 316a and 316b thereof are collected by the first and second scrap takeup spools 314c and 314g, respectively. The torques applied to the first and second product takeup spools 312c and 312g and to the first and second scrap takeup spools 314d and 314g tension the product portions 316a and 316b and scrap portions 318a and 318b, respectively.

As before, the slip clutches 312d, 312h, 314d and 314h are preferably adjusted such that the tension on the product portions 316a and 316b and scrap portions 318a and 318b are substantially equal, thereby substantially uniformly tensioning the paper-like medium 302 to minimize the likelihood of “puckering” of the paper-like medium 302.

The tensioning takeup techniques described hereinabove with respect to FIGS. 3A, 3B and 3C rely on slip clutches to maintain tension. As the punched medium (product) and scrap accumulate on the spools, the tension applied to the medium will decrease in proportion to increasing spool diameter. Assuming that all of the empty spools start out at the same diameter, they will increase in diameter at substantially the same rate as the medium accumulates on them, so the tensions will decrease in proportion, thereby maintaining even tension across the entire medium.

Those of ordinary skill in the art will immediately understand that more elaborate schemes can be employed to maintain constant tension. For example, separate torque motors can be used to drive each spool and constant tension can be maintained by adjusting the torque dynamically to compensate for increasing spool diameter, either in closed-loop fashion by direct measurement of tension or in open-loop fashion by calculating the spool diameters based upon paper travel. This more elaborate technique of using torque motors has the advantage that it readily accommodates spools of differing diameters, dynamically adjusting applied torque to maintain substantially constant tension across the medium. For either open-loop or closed-loop control of tension, appropriate initial tension settings can readily be determined (and automatically calculated) from the overall width of the medium and the widths of each of the product and scrap portions.

Those of ordinary skill in the art will also recognize that it is possible to use a single shaft for both product and scrap spools, provided that slits between product portions are cut with sufficient width to clear spool flanges between spools. Preferably, each spool would have its own separate tensioning device (e.g., slip clutch or torque motor).

Generally speaking, the drive systems for paper-like media described hereinabove rely on a positive feed mechanism that feeds paper into the cutting area from the supply side and uses the takeup spools as tensioning devices to keep the medium substantially flat in the cutting area. These drive systems have the advantage of keeping media tension low by way of comparison to techniques that “pull” the medium off of a heavy roll. With higher tension, there is increased risk of tearing or stretching of the medium.

Those of ordinary skill in the art will immediately understand that many other alternative media feed mechanisms are possible. For example, a much simpler scheme is possible whereby a driven takeup spool pulls the paper-like medium through the cutting area, relying upon drags either inherent in or engineered into the paper path to maintain tension on the paper. It is also possible to use guides and supports to keep the medium flat in the cutting area.

Those of ordinary skill in the art will further recognize that it is possible to operate the laser perforator of the present invention without slitting the medium into separate portions, thereby requiring a single takeup spool. In this case if slitting is required, it can be done later in a separate process.

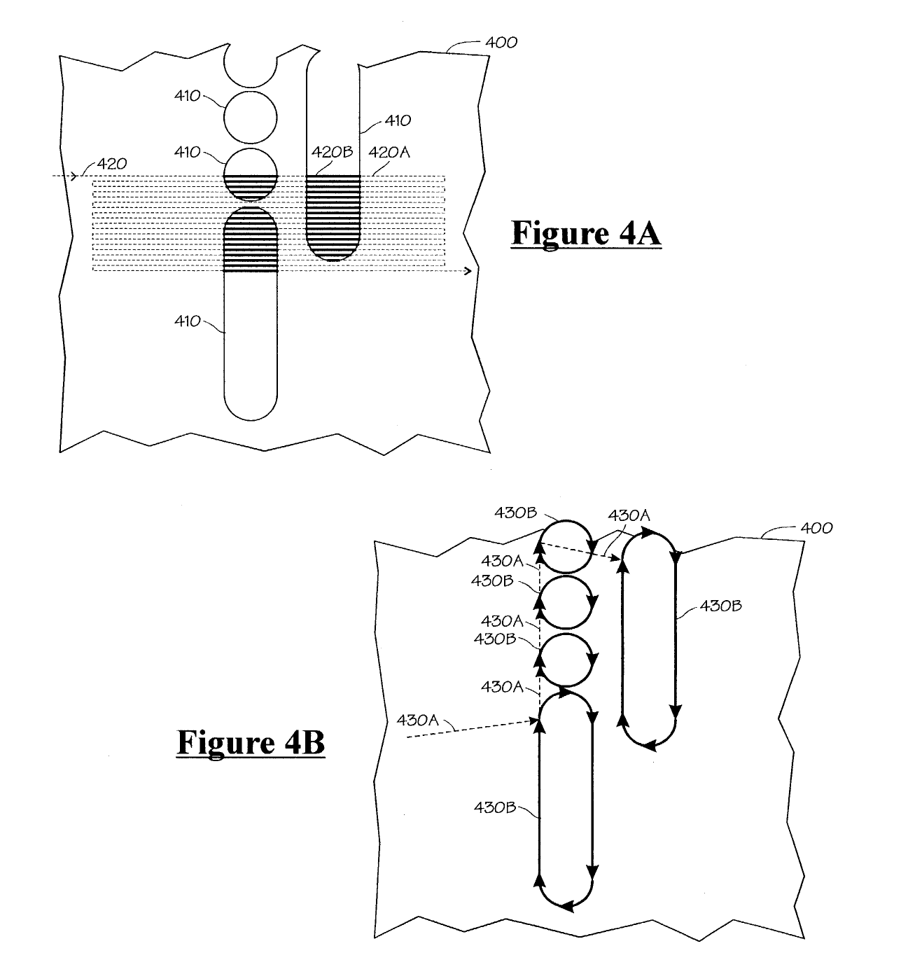

As described hereinabove, there are two primary modes of perforating/slitting: raster and vector. These two techniques are shown and described with respect to FIGS. 4A and 4B.

FIG. 4A is a diagram of a portion 400 of a paper-like music medium being perforated in raster fashion. Holes 410 are intended to be perforated by the laser perforator of the present invention. A raster path 420 comprising “beam off” portions 420A, shown by dashed line segments and “beam on” portions 420B, shown by solid line segments describe the path of the laser cutting head back and forth over the portion 400 of the medium. The raster path 420 is deliberately abbreviated for clarity and to reduce illustrative clutter. The laser beam is turned “on” (raised to a power level sufficient to perforate the medium) in the “beam on” portions 420A of the raster path 420 and turned off (reduced to a power level low enough that there will be no appreciable effect on the medium) such that the “beam on” portions 420A of the raster path coincide with the locations of holes 410 (and the interiors thereof) so that the medium is perforated in the desired pattern of the holes 410.

The raster path 420 is shown as a “serpentine” path, i.e., the laser head traces back and forth across the medium, cutting in both directions. Those of ordinary skill in the art will understand that single-direction raster perforation is also possible.

FIG. 4B is a diagram of a portion 400 of a paper-like music medium being perforated in vector fashion. In this case, however, the holes 410 (see FIG. 4A) are cut by tracing their outlines with the laser cutting head in a “beam on” condition and moving the laser cutting head between holes in a “beam off” condition. Dashed lines 430A indicate “beam off” motion of the cutting head between holes and over areas not to be cut, and solid lines 430B indicate “beam on” tracing of the hole outlines by the cutting head.

In the case of raster perforation, the interior of the holes is substantially burned away producing primarily smoke and vapors, but in the case of vector perforation, the hole interiors remain intact and fall away as “chips” or “chad”. Smoke, vapors and chips are all carried away by the ventilation and chip removal system (see 122, FIGS. 1A, 1B).

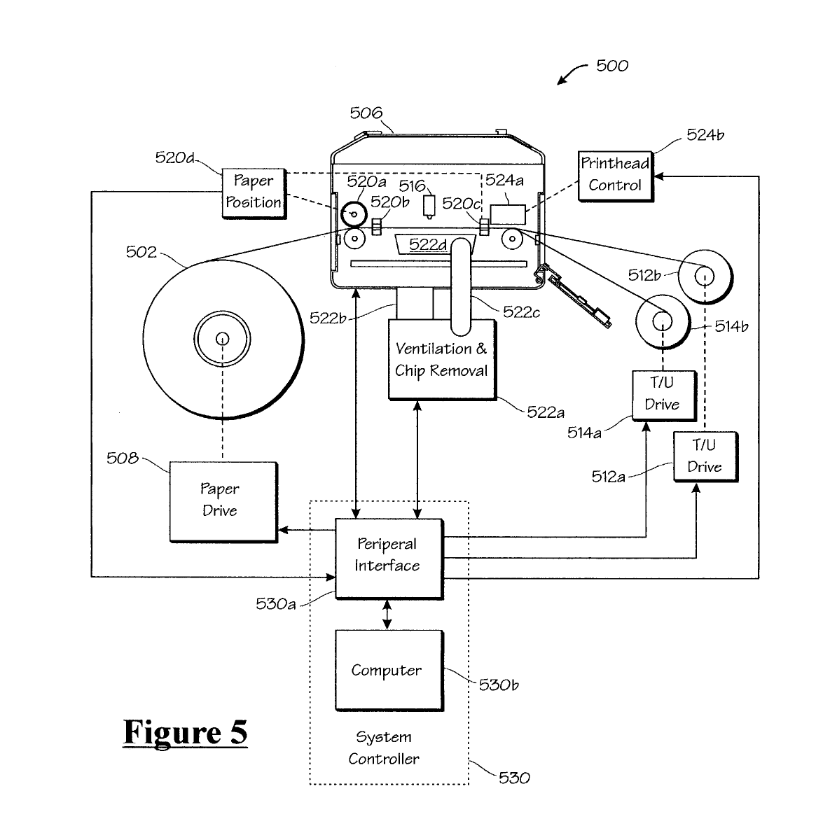

FIG. 5 is a block diagram of a system 500 for perforating a paper-like music medium 502 using a laser engraver 506 (compare 106, FIGS. 1A, 1B) with an X-Y cutting head 516. A paper drive mechanism 508 feeds the paper-like music medium 502 into the engraver 506 where it passes under the cutting head 516 to be perforated and/or slit as described hereinabove. A motion pickoff 520a, preferably a rubber “tire”, controls a paper position monitor 520d, preferably a rotary encoder, to indicate the amount of paper that has passed into the laser engraver 506. Paper edge position sensors 520b and 520c report the edge position of the paper-like medium as it enters and exits the cutting area. A printhead 524a is positioned to print on the paper-like medium 502 and is driven by a printhead controller 524b to print markings such as words, tempo markings, dynamic markings and/or graphics on the paper-like music medium 502. A product takeup drive 512a drives one or more product takeup spools 512b and a scrap takeup drive 514a drives one or more scrap takeup spools 514b. The product takeup spool(s) 512b and scrap takeup spool(s) 514b collect product and scrap portions, respectively, of the paper-like music medium after perforation and slitting. A ventilation and chip (chad) removal system 522a removes smoke, fumes and chips (e.g., paper chad) from the engraver by means of a ventilation duct 522b and a chip removal duct 522c. The chip removal duct 522c is further connected to a chip receiver mounted near the paper-like medium to receive chips and carry them into the chip removal duct.

A system controller 530 comprising a peripheral interface 530a and a computer 530b receives output from the paper position monitor 520d and edge sensors 520b and 520c and controls the laser engraver, the paper drive mechanism 508, the product takeup drive 512a and the scrap takeup drive 514a as necessary to cause appropriate motion of the paper-like medium 502 (e.g., continuous, stepped or “panelized” motion) to coordinate the cutting head's motions with the motion of the paper-like music medium 502 for proper perforation.

In addition, the system controller 530 can control and monitor the status of the ventilation and chip removal system 522 (522a,b,c,d) and the printhead 524a (via the printhead controller 524b). For example, the system controller can activate the ventilation and chip removal system 522 when perforating, monitor its status to ensure that it is functioning properly, and shut it down after perforation is completed. In the event of a ventilation failure, the system controller 530 can abort the perforation process and shut down the perforation system 500 in an orderly fashion to minimize risk of fire.

The system controller 530 can also control the printhead 524a via the printhead controller 524b to coordinate printing with the motion of the paper-like music medium 502. This facilitates such features as printing a graphical leader on a piano roll, printing a roll index or printing words on a music roll in synchronization with note perforations thereon.

The peripheral interface 530a provides electrical connectivity between the computer 530b and the various component parts of the system 500 (i.e., laser engraver 506, paper position monitor 520b, paper drive 508, etc..), and can be integrated into the computer 530b, or one or more portions thereof can be implemented as one or more separate interfaces. The computer 530b is preferably a personal computer or computer workstation, but can also be implemented as a dedicated controller.

The various components of the system 500 need not be physically separate from the peripheral interface 530a. For example, electronic circuitry for driving a paper drive motor could be integrated into the system controller 530. By way of further example, the printhead controller 524b could be integrated into the system controller 530. While physical contact or close proximity to the paper-like medium is required of certain components (e.g., laser cutting head 506, printhead 524a, pickoff 520a, etc.), much of the supporting electronics and other mechanism can be integrated into other portions of the system 500. That is, the functional blocks shown in FIG. 5 should not be interpreted as implying either physical separateness or specific organization of the components and functions represented.

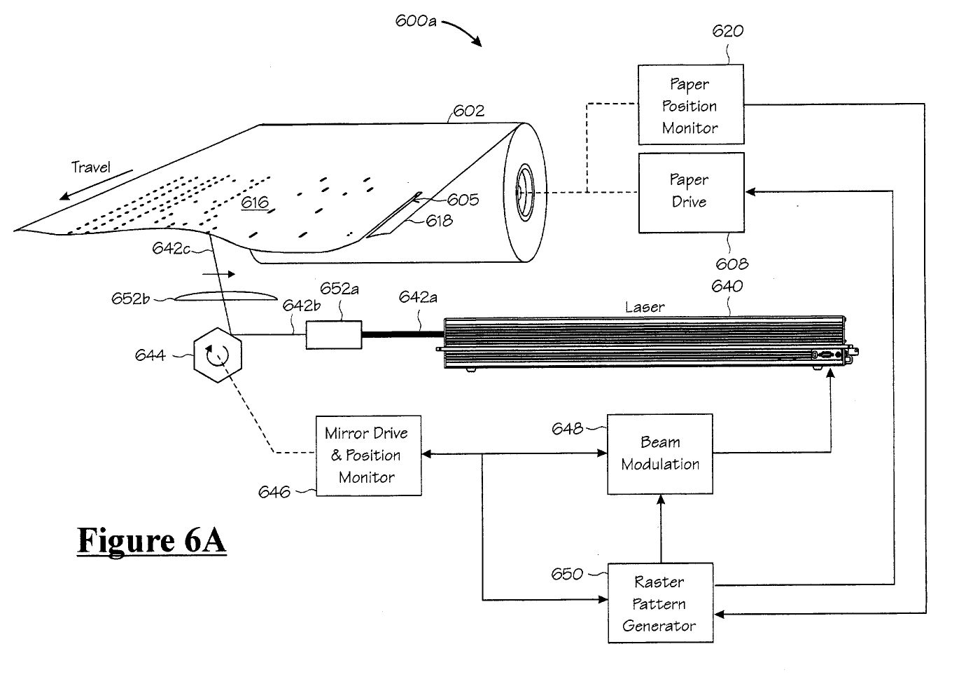

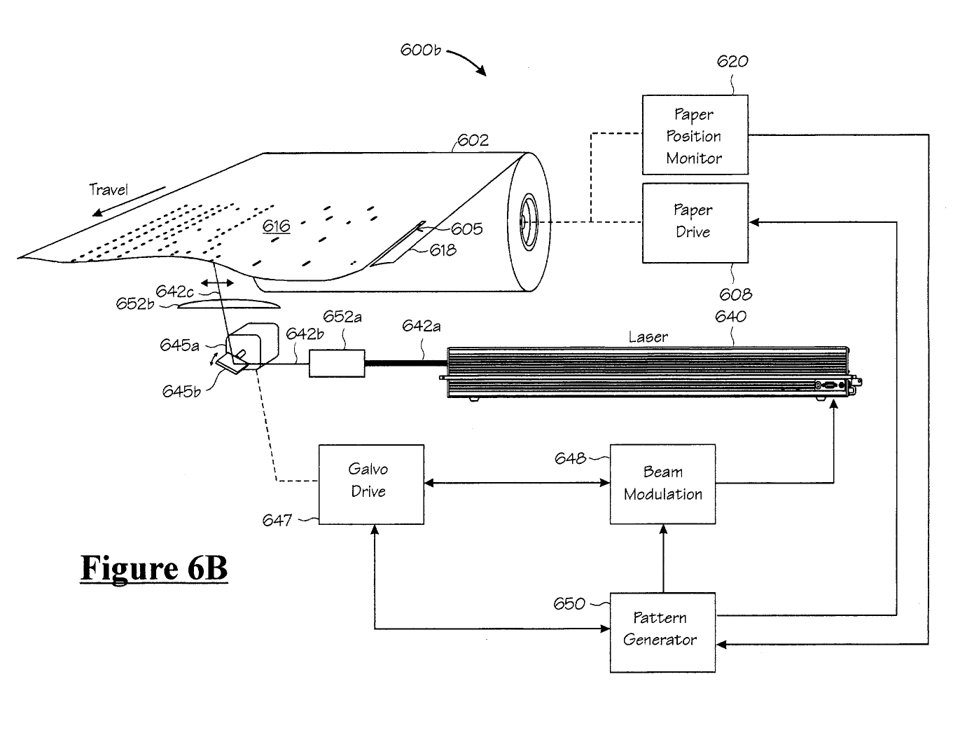

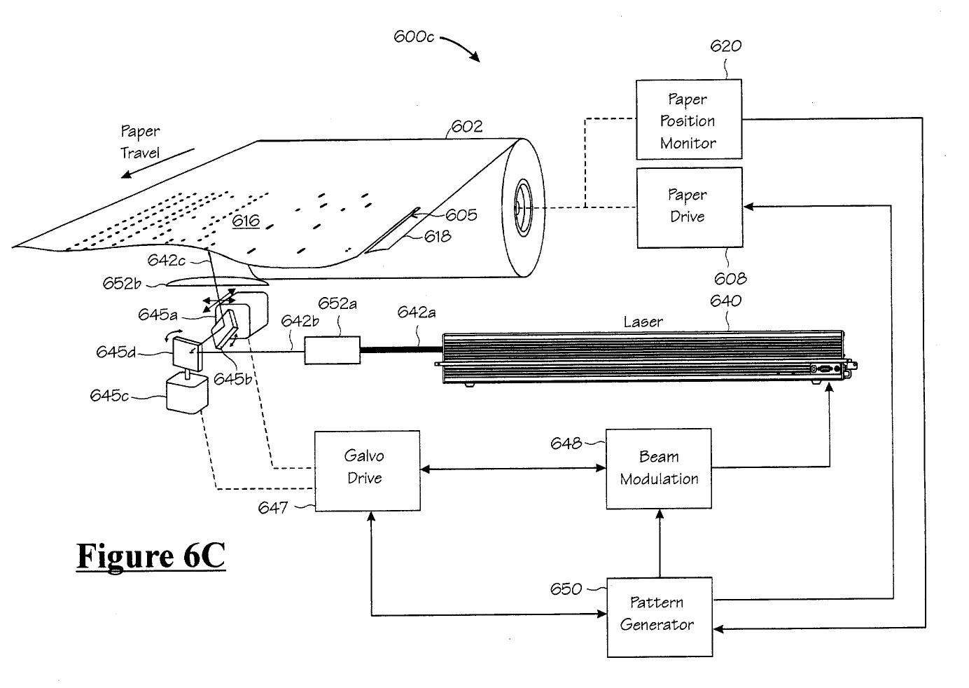

Although the embodiments described hereinabove are described with respect to a laser engraver with an X-Y cutting head. Other opto-mechanical configurations for directing a laser cutting beam can be employed, such as a rotating polygonal mirror or galvanometer-driven mirrors. Such configurations are described hereinbelow with respect to FIGS. 6A, 6B, and 6C.

FIG. 6A is a diagram of a laser perforating apparatus 600a using a polygonal mirror 644 to direct a cutting beam 642c. In the Figure, a laser 640 provides a source of high-energy, collimated light in the form of a laser beam 642a. A collimating/focusing optical element 652a reduces/focuses the beam 642a into a collimated beam 642b, which is in turn reflected off of a rotating polygonal mirror 644 to produce the swept cutting beam 642c. As the polygonal mirror 644 rotates, it causes the cutting beam 642c to sweep across a substantially planar paper-like music medium 602. The polygonal mirror 644 is driven by a mirror drive system 646. The mirror drive 646 system drives the mirror in a fashion such that its angular position is known at any time while the cutting beam 642c is sweeping across the music medium 602. A field-flattening optical element 652b compensates for varying path length via the rotating mirror 644 to the music medium 602, keeping the cutting beam 642c in focus across a substantial portion of its sweep. The cutting beam 642c repeated traces a line across the music medium 602. The music medium 602 is fed past the cutting beam 642c by a drive mechanism 608 so that the music medium advances slightly between passes of the cutting beam 642c, thereby permitting large areas of the music medium to be “painted” by the cutting beam 642c in a raster pattern. From a desired pattern of perforations/slits, a raster pattern generator monitors the position of the swept beam (via the mirror drive/position monitor 646) and the position of the music medium (via a position monitoring mechanism 620) and produces a desired on-off sequence for the laser 640. This sequence is provided to a beam modulation function 648, which causes the laser beam 642a (and 642b, 642c as a result) to be modulated in synchronism with the motion of the music medium 602 and cutting beam 642c to perforate the music medium and/or form a slit 605, producing one or more product portions 616 and/or scrap portions 618. The beam modulation function 648 can further modulate the laser 640 to compensate for sweep speed variations, increasing beam power where the cutting beam 642c sweeps faster and decreasing power where it sweeps slower. If a compensating shape is not used for facets of the polygonal mirror 644, the cutting beam 642c can be expected to sweep faster towards the end of its swept path.

Although the music medium 602 is shown as being substantially flat as it passes over the beam 642c, it can also travel a curved path or be formed into a partial cylindrical shape (e.g., to produce a constant beam length, eliminating the need for focal length compensation.) The functions of the optical elements 652a, 652b can be combined or eliminated, as appropriate, and placed either before or after the rotating polygonal mirror 644.

Those of ordinary skill in the art will immediately understand that the position of the rotating mirror 644 can be determined in many different ways, such as, encoding its position with an optical encoder, or controlling its speed accurately and producing a “beginning of sweep” pulse, then determining position as a function of time passed since the last pulse. A variety of techniques can be used to infer position of the music medium as well, such as direct encoding, stepping or synchronous drive. If the drive system is sufficiently steady (i.e., medium speed is substantially constant), then the amount of medium passed under the cutting beam 642c can be assumed to be the product of the speed of travel of the medium and elapsed time. Position monitoring and motion control techniques such as these are well known to those of ordinary skill in the art and will not be further elaborated upon herein.

FIG. 6B is a diagram of laser perforating apparatus 600b, similar to the laser perforating apparatus 600a of FIG. 6A, except that a galvanometer 645a and mirror 645b are substituted for the rotating polygonal mirror (644, FIG. 6A). The galvanometer 645a has an output shaft to which a mirror 645b is attached, such that as the galvanometer 645a turns its output shaft, the mirror is turned. The collimated beam 642b is reflected off of the mirror 645b to produce a swept beam 642c directed generally towards the music medium 602. The turning motion of the mirror 645b is arranged such that the swept beam 645c traces a path across the music medium 602. Unlike the rotating mirror 644 of FIG. 6A, the galvanometer 645a is driven such that it causes the mirror 645b to oscillate back and forth, in turn causing the swept beam 642c to oscillate back and forth across the music medium 602, thereby tracing a “serpentine” raster pattern across the music medium. As before, the pattern generator 650 and beam modulator 648 are employed to synchronize modulation of the laser 640 with the motion of the mirror 645b and the music medium 602, to produce the desired pattern of perforations and/or slits (605) on the music medium 602, thereby dividing it into one or more perforated product portions 616 and/or one or more scrap portions 618.

Those of ordinary skill in the art will immediately appreciate that one advantage of the galvanometer 645a and mirror 645b over the rotating mirror assembly 644 is that the galvanometer can be “commanded” by the galvanometer drive 647 to any angular position, thereby permitting the swept beam 642c to be “commanded” to any point along its path across the music medium 602. In the apparatus 600a shown in FIG. 6A, the swept beam was limited to continuous motion (not necessarily constant speed) across the music medium 602. In the apparatus 600b of FIG. 6B, however, the swept beam 645c can be slowed down, sped up, or even stopped as it travels its path across the music medium 602. The permits the beam to be slowed down to “dwell” over areas to be perforated or slit and moved rapidly between perforations/slits. By permitting slower motion of the beam in areas to be cut through, it is possible to use a lower power laser for some applications.

With the addition of a second galvanometer and mirror, it is possible to permit two-axis (two-dimensional) deflection of the swept beam over an area of the music medium. This is shown and described with respect to FIG. 6C.

FIG. 6C is a diagram of laser perforating apparatus 600c for a paper-like music medium 602 similar to laser perforating apparatus 600a and 600b shown and described hereinabove with respect to FIGS. 6A and 6B, except that a two-axis beam deflection arrangement comprising a first galvanometer 645a, a first mirror 645b, a second galvanometer 645c and a second mirror 645d are provided. In this case, the galvanometer drive 647 controls position of the first and second galvanometers 645a and 645c independently, thereby controlling the positions of the first and second mirrors 645b and 645d to deflect the cutting beam 642c in two axes. Unlike the single-axis rotating mirror 644 of FIG. 6A and the single galvanometer and mirror (645a, 645b) of FIG. 6B, the deflection arrangement of FIG. 6C permits the cutting beam 642c to be deflected to trace out complex shapes (such as perforation outlines) over a two-dimensional area of the paper-like music medium 602. This permits vector-mode cutting as described hereinabove with respect to FIG. 4B.

The pattern generator 650 and beam modulator 648 are employed to synchronize modulation of the laser 640 with the motion of the mirror 645b and the music medium 602, to produce the desired pattern of perforations and/or slits 605, such as hole outlines, on the music medium 602, thereby dividing it into one or more perforated product portions 616 and/or one or more scrap portions 618.

The apparatus 600c of FIG. 6c has a potential advantage over a laser perforator built around a commercial X-Y laser engraver in that the galvanometers/mirrors have very low mass compared to the optical head, arms, etc., of a typical X-Y engraver such as those manufactured by Great Computer Corporation, Universal Laser Systems, Epilog, and others. This means that the beam can be “moved” from point to point on the music medium more rapidly than would be possible with laser engraver. This permits the cutting beam to be directed very rapidly between perforations, greatly speeding yup perforation. Further, the vector cutting approach has the advantage that it only cuts outlines of perforations and other shapes, rather than having to burn away the entire interior of those shapes and trace over large areas of imperforate medium. This can potentially greatly speed up overall perforator operation, and by permitting the cutting beam to dwell only outlines to be cut, may permit a lower power laser to be used.

It will be readily appreciated by those of ordinary skill in the art that converging and field-flattening optics of the type described hereinabove with respect to FIGS. 6A, 6B, and 6C can be expensive and difficult to align, especially when both a small spot size and a large cutting area (or length—FIGS. 6A, 6B) are desired. It is generally much simpler and much less expensive to provide converging/field-flattening optics to maintain a small spot size over a smaller cutting area (or length).

X-Y “Marking” heads capable of producing a small spot size (highly focused laser beam of a few thousandths of an inch in diameter) over a relatively small area (a few square inches) are commercially available from a number of sources, including Synrad, Inc. of Mukilteo, Wash. Such heads are often used for marking parts, or for producing repeating patterns on a variety of media. These heads generally employ galvanometer driven mirrors or similar techniques for beam deflection, and provide for control of beam power. Laser spot size, however, is dependent upon the size of the cutting area desired. The smallest spot sizes can be maintained only over relatively small areas. For example, Synrad specifies that using its FH series marking head, a spot size of 0.007″ can be employed over a working area of about 2.5 inches square (6.25 square inches).

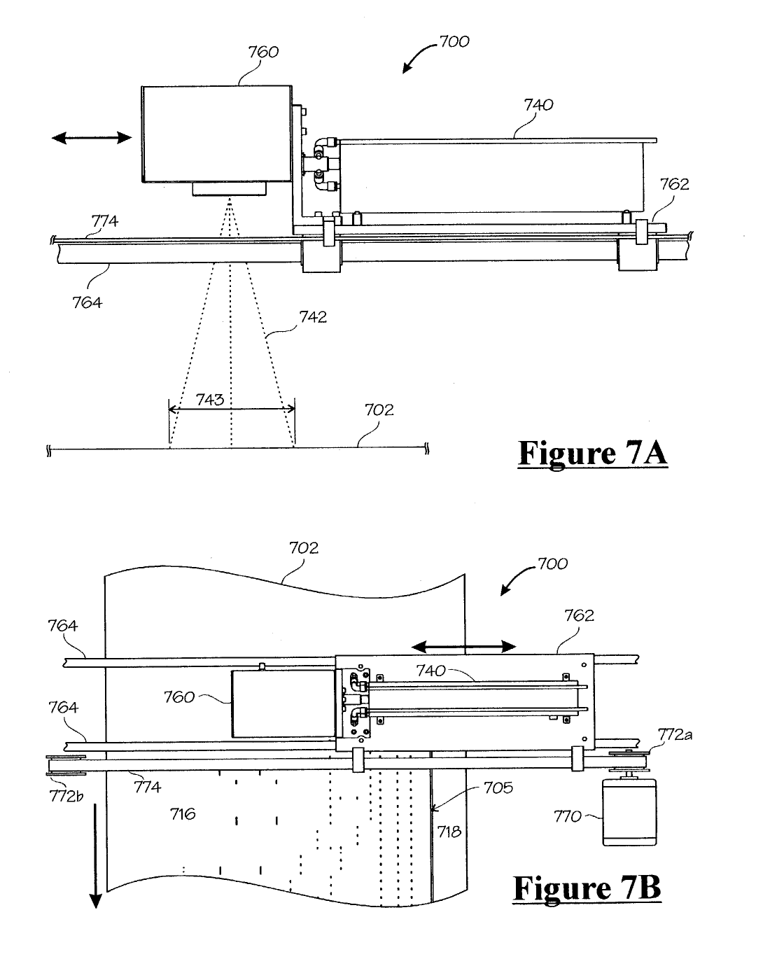

FIGS. 7A and 7B are a side view and a top view, respectively, of a laser perforator head 700 for perforating a paper-like music medium 702, employing such a marking head 760. A laser 740 provides a source of a cutting beam 742 to be deflected by the marking head 760. The marking head is positioned an appropriate focal distance away from the music medium 702 such that the cutting beam 742 can be deflected over a cutting area 743. The laser 740 and cutting head 760 are mounted to a support bracket 762, which is in turn slide-mounted to a pair of guide rails 764. The slide-mounted bracket 762 and rails 764 in effect form a “gantry” by which the laser 740 and marking head 760 can be moved back and forth along the rails 764 such that the cutting area 743 can be repositioned to cover any desired position across the with of the music medium 702. A gantry drive motor 770 drives a first sprocket 772a. A gantry drive belt 774 passes around the first sprocket 772a and a second sprocket 772b, and attaches to the support bracket 762 such that the gantry drive motor 772 moves the laser 740 and marking head 760 along the rails 764 over the music medium 702. By coordinating the cutting action of the marking head 760 with motion of the marking head, perforations and/or one or more slits 705 can be made in the music medium 702 anywhere across the entire width of the music medium 702, thereby dividing into one or more product portions 716 and/or one or more scrap portions 718

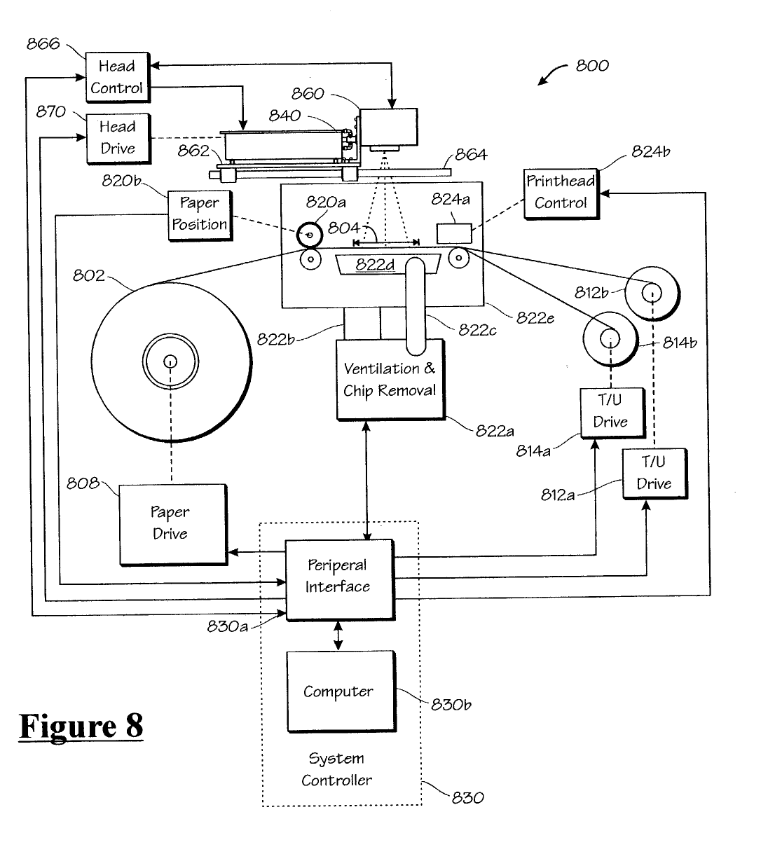

FIG. 8 is a block diagram of a system 800 for perforating a paper-like music medium 802 using a marking head 860 and laser 840 (compare 740, 760, FIGS. 7A, 7B). The system 800 is similar in many respects to the system 500 shown and described hereinabove with respect to FIG. 5. A paper drive mechanism 808 feeds the paper-like music medium 802 under the marking head 860 to be perforated and/or slit as described hereinabove. A motion pickoff 820a, preferably a rubber “tire”, operates a paper position monitor 820b, preferably a rotary encoder, to indicate the amount of paper that has passed under the marking head 860. A printhead 824a is positioned to print on the paper-like medium 802 and is driven by a printhead controller 824b to print markings such as words, tempo markings, dynamic markings and/or graphics on the paper-like music medium 802. A product takeup drive 812a drives one or more product takeup spools 812b and a scrap takeup drive 814a drives one or more scrap takeup spools 814b. The product takeup spool(s) 812b and scrap takeup spool(s) 814b collect product and scrap portions, respectively, of the paper-like music medium after perforation and slitting. A ventilation and chip (chad) removal system 822a removes smoke, fumes and chips (e.g., paper chad) from the engraver by means of a ventilation duct 822b and a chip removal duct 822c. The chip removal duct 822c is further connected to a chip receiver 822d mounted near the paper-like medium to receive chips and carry them into the chip removal duct.

A system controller 830 comprising a peripheral interface 830a and a computer 830b receives output from the paper position monitor 820b and controls the laser 840 and marking head (via a head control function 866, typically built into the marking head and/or its associated equipment), the paper drive mechanism 808, the product takeup drive 812a, the scrap takeup drive 814a and a gantry drive mechanism 870 (compare 770, 772a,b, 774, FIGS. 7A, 7B) as necessary to cause appropriate motion of the paper-like medium 802 (e.g., continuous, stepped or “panelized” motion) and to coordinate motion of the marking head 860 and modulation of the laser 840 with the motion of the paper-like music medium 802 for proper perforation and/or slitting. As the paper-like medium 802 and marking head 860 are moved relative to one another, deflection of the cutting beam is adjusted to track and compensate for the motion. This motion correction is accomplished and coordinated by the system controller 830 by means of positional feedback from the paper drive and the head control 866.

A ventilation housing 822e surrounds a cutting area 804 where the paper-like music medium 802 is perforated/slit. Considerable smoke and/or fumes can be generated in this area, and the ventilation housing 822e contains these fumes and permits their proper removal by the ventilation and chip removal system 822a. Preferably, the ventilation housing 822e is mode of a material that blocks light from the laser 840 (e.g., acrylic for CO2 lasers), providing protection for bystanders against injury.

As in the system of FIG. 5, the system controller 830 can control and monitor the status of the ventilation and chip removal system 822 (522a,b,c,d) and the printhead 824a (via the printhead controller 824b). For example, the system controller can activate the ventilation and chip removal system 822 when perforating, monitor its status to ensure that it is functioning properly, and shut it down after perforation is completed. In the event of a ventilation failure, the system controller 830 can abort the perforation process and shut down the perforation system 800 in an orderly fashion to minimize risk of fire.

The system controller 830 can also control the printhead 824a via the printhead controller 824b to coordinate printing with the motion of the paper-like music medium 802. This facilitates such features as printing a graphical leader on a piano roll, printing a roll index or printing words on a music roll in synchronization with note perforations thereon.

The peripheral interface 830a provides electrical connectivity between the computer 830b and the various component parts of the system 500 (i.e., head control 866, head drive 870, paper position monitor 520b, paper drive 508, etc..), and can be integrated into the computer 830b, or one or more portions thereof can be implemented as one or more separate interfaces. The computer 830b is preferably a personal computer or computer workstation, but can also be implemented as a dedicated controller.

The various components of the system 800 need not be physically separate from the peripheral interface 830a. For example, electronic circuitry for driving a paper drive motor could be integrated into the system controller 830. By way of further example, the printhead controller 824b could be integrated into the system controller 830. While physical contact or close proximity to the paper-like medium is required of certain components (e.g., marking head 860, printhead 824a, pickoff 820a, etc.), much of the supporting electronics and other mechanism can be integrated into other portions of the system 800. That is, the functional blocks shown in FIG. 8 should not be interpreted as implying either physical separateness or specific organization of the components and functions represented.

As described hereinabove, a typical commercial marking head (such as the Synrad FH series) cannot provide both a small spot size and a large “marking” (cutting) area. In order to overcome this limitation for the purpose of perforating/slitting music media wider than the longest dimension of the marking head's marking area, the marking head can be gantry mounted as shown and described hereinabove with respect to FIGS. 7A, 7B and 8, and moved across the music medium to cover the entire width thereof. As the gantry-mounted marking head and paper-like music medium are moved, the system controller (see 830, FIG. 8) compensates for that motion by adjusting cutting coordinates sent to the marking head, effectively creating a moving coordinate system.

One method of moving the gantry mechanism to cause the marking head's cutting area to sweep over the entire surface of the music medium is to move the gantry back and forth above the music medium, creating a serpentine sweep of the marking head over the music medium. Preferably, the “sweeps” of the cutting area overlap. As the sweep process progresses, new areas of the music medium become available for cutting and “old” areas become unavailable for cutting. With overlap of the sweep passes, some areas of the medium will pass under the marking head more than once. Preferably, faced with a choice of which items (perforations or slits) to cut first, the system controller prioritizes commands to the cutting head so that areas of the music medium which will become unavailable for cutting soonest are processed (perforated or slit) first.

Those of ordinary skill in the art will also realize that other sweep schemes are possible. For example, both music medium and marking head can be moved in discrete steps, stopping periodically to cut an area of the music medium, effectively cutting the music medium in a series of “tiles”.

The present inventive technique has a number of advantages over prior art techniques for perforating music media. Prior-art perforators, usually mechanical step-advance die-punching machines, have a “punch step” increment, i.e., a minimum distance between punches. As described hereinabove, a typical punch-step increment for American 88-note piano rolls is on the order of 1/30 of an inch. The laser perforator of the present invention has an effective punch step increment as small as the laser engraver, marking head, or other laser cutting apparatus can resolve—typically less than 0.001 inch. At a tempo of 50 (music medium speed across a “tracker bar” or its equivalent of 5 feet/minute or 1 inch per second), this means that the temporal resolution of a typical prior-art perforation technique is not better than 33 milliseconds, while the temporal resolution of the present invention is typically 1 millisecond or less. The 33 millisecond resolution corresponds to 30 events per second—within the range of human temporal perception under certain conditions—while the 1 millisecond resolution is well below the threshold of perception. Even with the speed of the medium doubled to tempo 100 (2 inches per second—generally considered a fairly fast speed for roll playing instruments) the temporal resolution for the prior-art technique is only improved to 17 milliseconds; still relatively coarse by some standards.

Various aspects of the present inventive technique for laser perforation of music media enable capabilities previous impossible using prior-art techniques. Some examples are:

switching between different perforation formats for media of the same width (e.g., between 11.25 inch “A” roll format at 6 holes per inch and 11.25 inch 88-note format at 9 holes per inch) requires no change of setup.

switching between product formats of differing widths (but using the same basic medium, e.g., paper) requires only adjustment of receiving product and/or scrap spool widths

no die changes are ever required

media can be perforated face-up, face-down, head-first or tail-first without change of physical setup (assuming spool directions are reversible).

media are slit to width while perforating, permitting the use of standard bulk media (e.g., 12 inch wide dry waxed kraft paper, slit to 11.25″ width while perforating)

two or more products can be perforated at once

products of differing format, width, and/or hole spacing can be perforated simultaneously

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A perforator for music media, comprising:
a laser providing a cutting beam;
means for focusing/converging the cutting beam;
means for passing a paper-like music medium under the cutting beam;
means for moving the cutting beam over the planar, paper-like medium to form perforations therein.

2. A perforator for music media according to claim 1, further comprising:
means for moving the cutting beam in a raster pattern over the paper-like medium.

3. A perforator for music media according to claim 1, further comprising:
means for moving the cutting beam in a vector pattern over the paper medium.

4. A perforator for music media according to claim 1, wherein:
the paper medium is moved in a stepped fashion.

5. A perforator for music media according to claim 1, wherein:
the paper medium is moved in a continuous fashion.

6. A perforator for music media according to claim 1, wherein:
the paper medium is moved in an indexed fashion.

7. A perforator for music media according to claim 1, further comprising:
means for moving the cutting beam to slit the paper-like medium to a predetermined width.
